(19) United States
(12) Patent Application Publication
(10) Pub. No.: US 2022/0379492 A1
(43) Pub. Date: Dec. 1, 2022

(54) INFORMATION PROCESSING DEVICE AND INFORMATION PROCESSING METHOD

(71) Applicant: Hitachi, Ltd., Tokyo (JP)

(72) Inventors: Hiroshi ITO, Tokyo (JP); Kenjiro YAMAMOTO, Tokyo (JP)

(21) Appl. No.: 17/772,281

(22) PCT Filed: Aug. 12, 2020
(86) PCT No.: PCT/JP2020/030673

§ 371 Date: Apr. 27, 2022

(30) Foreign Application Priority Data
Nov. 20, 2019 (JP) 2019-209482

(51) Int. Cl. B25J 13/08; G06V 10/774

(52) U.S. Cl. CPC B25J 13/089; G06V 10/774

(57) ABSTRACT

Provided is a configuration for generating pseudo sensor data from a plurality of pieces of existing sensor data. This information processing device which generates time-series learning data on the basis of time-series original data acquired from a robot device comprises: a memory that stores at least one extended data generation rule comprising at least one velocity change value, at least one phase change value, at least one position change value, or at least one magnitude change value; and a processor that generates time-series extended data by data expansion of the original data using at least one change value of the extended data generation rule, and outputs time-series learning data including the time-series extended data and the time-series original data.

### TECHNICAL FIELD

The present invention relates to an information processing device and an information processing method that generate a large amount of learning data for machine learning based on a small amount of original data and use the learning data in the large amount to execute machine learning.

### BACKGROUND ART

Machine learning including deep leaning is attracting attention as a learning method that accurately enables complex recognition and identification, which have been previously difficult. For efficient machine learning, a sufficient number of learning data items are required. For example, in deep learning in the image recognition field, object recognition accuracy that exceeds conventional methods is achieved by using tens of thousands to hundreds of millions of image data items as learning data.

As a literature that discloses deep learning in the image recognition field, for example, there is Non-Patent Literature 1. This literature discloses a method for parametrically transforming image data to generate pseudo learning data, that is, a plurality of pseudo learning data items. As examples of the parametrical transformation used in this literature, there are brightness adjustment, inversion, distortion, scaling, and the like of images.

In addition, Patent Literature 1 discloses a data generation device that generates pseudo biological data from biological data that is time-series data. The data generation device generates, in advance, pseudo data in which daily fluctuations in biological data are reflected to improve the accuracy of the recognition of a wearer and a wearing state.

### CITATION LIST

### Patent Literature

Patent Literature 1: Japanese Patent Application Laid-Open No. 2019-25311

### Non-Patent Literature

Non-Patent Literature 1: Ciresan et al., “Deep Big Simple Neural Nets Excel on Handwritten Digit Recognition”, Computation, December 2010, Vol. 22, No. 12

### SUMMARY OF INVENTION

### Technical Problem

As a method for generating a robot motion using deep learning, multimodal deep learning that simulates human information processing has been proposed. The multimodal deep learning processes and learns a plurality of sensor information items (for example, an image, audio, a text, and the like) in an integrated manner to make it possible to autonomously perform flexible motions for operations of objects with complex shapes that were previously difficult, and complex environmental changes. However, to cause a robot to learn to grip a moving target object, there has been a problem that it is necessary to prepare a large amount of learning data such as the moving speed of the target object and the timing of gripping the target object and large calculation cost is required.

Therefore, an object of the present invention is to provide an information processing device that can easily generate a large amount of learning data based on a small amount of original data to make it possible to easily execute deep learning even under a complex environment in which a robot device grips a moving target object.

### Solution to Problems

To solve the aforementioned problems, an information processing device according to the present invention generates time-series learning data based on time-series original data acquired from a robot device and includes a memory that stores an augmented data generation rule for at least one of at least one change value of a speed, at least one change value of a phase, at least one change value of a position, or at least one change value of a size, and a processor that uses at least one of the change values of the augmented data generation rule to augment the original data so as to generate time-series augmented data and outputs the time-series learning data including the time-series augmented data and the time-series original data.

### Advantageous Effects of Invention

According to the information processing device according to the present invention, since it is possible to easily generate a large amount of time-series learning data based on a small amount of time-series original data, it is possible to execute appropriate machine learning based on a large amount of learning data even under a complex environment in which a robot hand of a robot device grips a moving object.

### BRIEF DESCRIPTION OF DRAWINGS

FIG. 1 is a functional block diagram of a robot system according to an embodiment.

FIG. 2 illustrates an example of a hardware configuration of the robot system according to the embodiment.

FIG. 3 is a flowchart illustrating a motion teaching routine.

FIG. 4 is a flowchart illustrating a machine learning routine.

FIG. 5 is a flowchart illustrating a motion generation routine.

FIG. 6 illustrates an example of speed data generated by a speed calculator.

FIG. 7 illustrates an example of image data generated by a hand end position calculator.

FIG. 8 illustrates an example of phase data generated by a phase calculator.

FIG. 9 illustrates an example of learning data integrated by a data processing unit.

### DESCRIPTION OF EMBODIMENTS

First, terms to be used to explain the present invention are described. “Sensor data” is a measured value (joint angle, current value, torque value, tactile value, or the like) of a sensor that measures a state of each drive unit (actuator) of a robot device or a measured value (camera image or the like) of a sensor (camera, motion capture, or the like) attached outside the robot device and configured to measure surroundings. In addition, “learning data” is a series of sensor data to be used to teach a target motion to the robot device and is time-series data associated with a measurement time and a measured value.

As described in “Background Art”, machine learning is attracting attention as a method for accurately enabling complex recognition and identification, which have been previously difficult. In a case where this machine learning is used for the robot device, even when an environment changes, it is possible to autonomously generate an appropriate motion by teaching a large number of target motions to the robot device and causing the robot device to learn the motions via machine learning.

However, many of examples of the application of the machine learning to the robot device are provided for relatively easy object operations such as gripping a stationary target object, and there were very few examples of application to complex object operations such as gripping an approaching moving target object on a conveyor belt. This is due to the fact that a large amount of learning data such as different moving speeds of a moving target object and different timings of gripping the moving target object is required to learn to grip the moving target object and it is difficult to prepare such a large amount of learning data.

Therefore, in the present embodiment, by improving a method that is called data augmentation and disclosed Non-Patent Literature 1 or the like, it is possible to easily generate sufficient learning data required for machine learning of an object operation in which the robot device grips a moving target object. The data augmentation method described in Non-Patent Literature 1 or the like generates pseudo data from existing data and increases data applicable to machine learning. As described above, Non-Patent Literature 1 discloses the data augmentation method in the image recognition field, and the data augmentation method generates a plurality of pseudo learning data items by performing, on acquired image data, parametrical transformation such as brightness adjustment, inversion, distortion, scaling, and the like. In addition, Patent Literature 1 discloses a data augmentation method that is suitable for characteristics of biological data and generates a plurality of pseudo learning data items by performing parametrical transformation on an amplitude and a time lag of biological data shown in chronological order.

Regarding data augmentation of image data, for example, adjusting the brightness of an image simulates a change in a characteristic, which is brightness in a natural image. Image scaling simulates a difference between images in terms of a characteristic, which is a distance between a target object to be recognized and a camera. A method for augmenting image data is a data augmentation method that takes into account a factor that changes a characteristic of an image. In addition, regarding data augmentation of biological data, for example, adjusting an amplitude of data simulates a change in a characteristic, which is the intensity of an active state in biological information. Changing the timing of data simulates a change in a characteristic, which is a time when an external stimulus has been received. An improvement in a recognition rate is achieved by using such a data augmentation method to generate, in advance, data in which a change in a characteristic of assumed data is reflected.

However, the data augmentation methods disclosed in Non-Patent Literature 1 and Patent Literature 1 are not suitable for data augmentation of sensor data of the robot device. This is due to the fact that both literatures only disclose the data augmentation methods for one sensor data item, and a different type of data augmentation method not disclosed in those literatures is required for a robot device constituted with a plurality of sensor data items having different characteristics.

Therefore, the present invention provides a data generation method that enables data augmentation for each sensor data item of the robot device that has been acquired from a plurality of sensors. In addition, the present invention provides a motion generation method for generating a large amount of learning data from a small amount of data by applying data augmentation to a small amount of sensor data, thereby being able to achieve sufficient motion generation performance. Therefore, the present invention provides an information processing device that focuses on characteristics required for task execution for sensor data shown in chronological order.

More specifically, the present invention targets sensor data relating to the generation of a motion of gripping a moving target object. That is, it is possible to sequentially generate a gripping motion of the robot device based on a target object in image data and the state of the robot device. For example, in a case where a motion of gripping a moving target object is generated, it is possible to clearly and easily identify a motion timing and a motion speed from a change in an image. However, it is difficult to estimate, from only a change in an image, a gripping motion command to the robot device, for example, a motion speed and a command value for each joint.

Therefore, the present invention provides a data augmentation method for augmenting two types of sensor data (image data and a command value of the robot device) having totally different characteristics. Therefore, it is possible to generate pseudo data for generating a motion of gripping various moving target objects. Furthermore, it is possible to generate various motions for an environmental change by machine learning to which such pseudo data is applied as learning data.

Hereinafter, an embodiment of the present invention is described with reference to the drawings. Since the following description is an example of the embodiment of the present invention, and it is possible to make modifications or changes as appropriate depending on various conditions, the present invention is not limited to the following embodiment.

### (Schematic Configuration of Robot System)

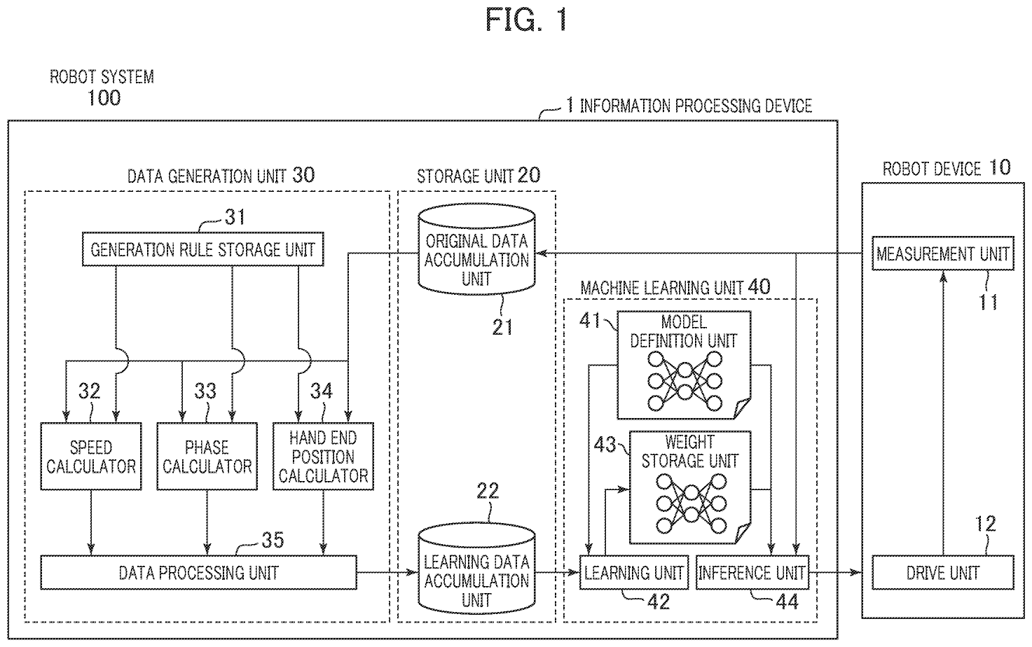

FIG. 1 is a functional block diagram illustrating a configuration example of a robot system 100 according to the embodiment of the present invention. As illustrated in FIG. 1, the robot system 100 includes an information processing device 1 and a robot device 10.

The robot device 10 is a robot including a plurality of measurement units 11 and a plurality of drive units 12. For example, the robot device 10 is an articulated robot having a robot hand for gripping a target object. The robot device 10 enables a desired motion, such as a motion of tracing and gripping a moving target object, by causing the plurality of drive units 12 to change an angle of each joint or the like. Each of the drive units 12 may be driven by an electric motor or may be driven by an actuator operated by fluid pressure such as hydraulic pressure or pneumatic pressure. In the present embodiment, the articulated robot is used as an example of the robot device 10, but a target to be controlled by the information processing device 1 may be another type of machine other than robot devices as long as the information processing device 1 can control numerical values.

The information processing device 1 acquires sensor data from the measurement units 11 of the robot device 10 and outputs a motion command value to the drive units 12 of the robot device 10. The information processing device 1 includes a storage unit 20, a data generation unit 30, and a machine learning unit 40.

First, a hardware configuration of the information processing device 1 is described below. After that, each of various processes to be performed by the information processing device 1, that is, a method for causing the robot device 10 in actual operation to autonomously generate a motion by teaching the robot device 10 a motion of gripping an approaching moving target object on a conveyor belt, generating learning data augmented based on time-series original data acquired from the robot device 10, and using the generated learning data in a large amount to learn a machine learning model.

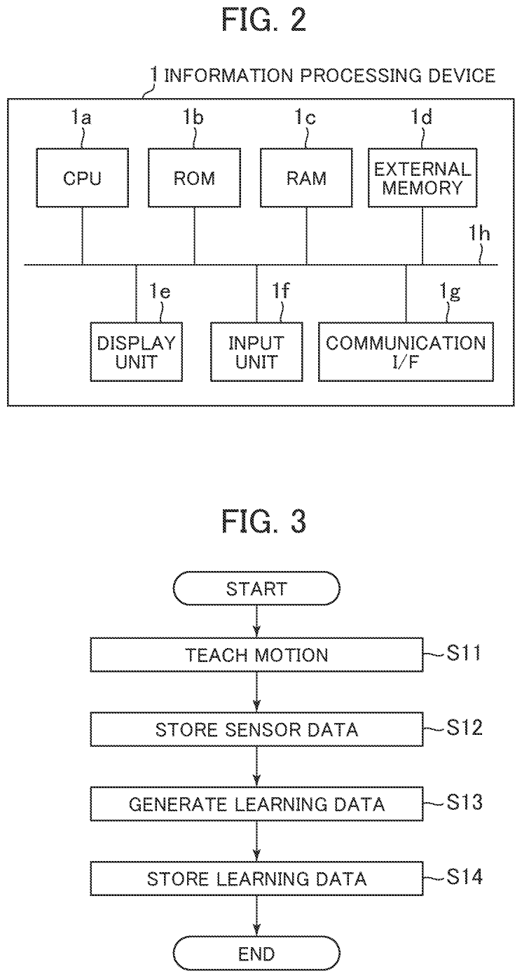

FIG. 2 is a diagram illustrating an example of the hardware configuration of the information processing device 1. As illustrated in FIG. 2, the information processing device 1 is a computer that includes a CPU 1a that is a processor, a ROM 1b that is a memory, a RAM 1c, an external memory 1d, a display unit le that is a user interface, an input unit 1f, a communication interface 1g, and a system bus 1h.

The CPU 1a comprehensively controls an operation of the information processing device 1 and controls the entire robot system 100 via the system bus 1h. The ROM 1b is a nonvolatile memory that stores a program necessary for the CPU 1a to execute processing and the like. The program may be stored in an external memory or a detachable storage medium. The RAM 1c functions as a main memory of the CPU 1a, a work area of the CPU 1a, or the like. That is, the CPU la loads the required program or the like from the ROM 1b into the RAM lc for the execution of processing and executes the program or the like to execute various functional operations of the data generation unit 30, the machine learning unit 40, and the like. The external memory 1d can store various types of data and various types of information necessary for the CPU 1a to execute processing using the program. In addition, the external memory 1d can store various types of data, various types of information, and the like that have been obtained by executing processing by the CPU 1a using the program. The external memory 1d may store the above-described learning data.

The display unit 1e is constituted by a monitor such as a liquid crystal display (LCD). The input unit 1f is constituted by a keyboard or a pointing device such as a mouse such that a user can provide an instruction to the information processing device 1. The communication interface 1g is an interface for communicating with an external device such as the robot device 10. The communication interface 1g can be a LAN interface, for example. The system bus 1h connects the CPU1a, the ROM 1b, the RAM 1c, the external memory 1d, the display unit 1e, the input unit lf, and the communication interface 1g to each other such that the CPU1a, the ROM 1b, the RAM lc, the external memory 1d, the display unit 1e, the input unit 1f, and the communication interface 1g can communicate with each other.

The data generation unit 30 that is implemented by the CPU 1a is configured to generate time-series learning data based on time-series sensor data acquired from the robot device 10. In addition, the machine learning unit 40 that is implemented by the CPU 1a is configured to execute machine learning on a model of the robot device 10 using the time-series learning data generated by the data generation unit 30, use the learned model to recognize a target object in an actual image and generate an appropriate gripping motion, that is, a motion command value of the drive units 12, and output the motion command value to the robot device 10. The machine learning is executed on the model by a convolutional neural network (CNN) and a recurrent neural network (RNN), which are types of deep learning, in the machine learning unit 40. The machine learning using these networks is a known learning method, and detailed descriptions thereof are omitted.

In the present embodiment, before the machine learning, the robot hand of the robot device 10 actually performs a gripping motion at least once. This motion is called motion teaching and is a method for using remote control of the robot device 10 by a person, direct teaching in which a person directly operates the robot hand of the robot device 10, or the like to teach a method for gripping a moving target object to the robot device 10. In addition, at the time of the execution of the machine learning, first, the information processing device 1 acquires, as original data, sensor data (joint angle, torque value, current value, and the like) of the measurement units 11 and a camera image (depth image or the like) at the time of the actual gripping of the target object, and the data generation unit 30 generates a large amount of learning data based on the original data.

Then, the machine learning unit 40 uses the generated learning data in the large amount to learn the machine learning model. The data generation unit 30 and the machine learning unit 40 are briefly described below.

### (Data Generation Unit 30)

As illustrated in FIG. 1, the data generation unit 30 includes a generation rule storage unit 31, a speed calculator 32, a phase calculator 33, a hand end position calculator 34, and a data processing unit 35. The generation rule storage unit 31 stores a generation rule for augmented data described later. The speed calculator 32 changes a speed of the original data acquired from the storage unit 20 based on the generation rule. The phase calculator 33 changes a phase of the original data based on the generation rule. The hand end position calculator 34 changes, based on the generation rule, the position of a hand end of the robot device 10 that is indicated in the original data.

In this case, the generation rule stored in the generation rule storage unit 31 is a rule including at least one change value of speed information, at least one change value of phase information, and at least one change value of hand end position information.

The original data acquired from the storage unit 20 is time-series data as the basis of the generation of learning data and includes sensor data of the robot device 10 at the time of a gripping motion and image data obtained by imaging the target object. The learning data is data of a series of motions at the time of the gripping motion as time-series data and is a pair of the imager data to be used for learning and the sensor data of the robot device 10. The image data includes at least one of a RGB color image, a depth image (distance image), and a monochrome image.

At least one sensor data item processed by the data processing unit 35 is accumulated as learning data in a learning data accumulation unit 22 of the storage unit 20.

### (Machine Learning Unit 40)

As illustrated in FIG. 1, the machine learning unit 40 includes a model definition unit 41, a learning unit 42, a weight storage unit 43, and an inference unit 44. The model definition unit 41 defines a model specified by a user in advance. The learning unit 42 uses a large amount of learning data accumulated in the learning data accumulation unit 22 to learn an optimal parameter for the model in accordance with an objective function. The weight storage unit 43 stores the optimal parameter provided for the model and obtained by the learning. The objective function of the learning unit 42 is specified by the user. In the present embodiment, since the gripping of the moving target object is described as an example, the parameter for the model constituting a machine learning device is optimized such that a motion command value of the robot device 10 at a time t+1 can be estimated from various types of sensor data at a time t. The inference unit 44 infers the motion command value of the robot device 10 based on the sensor data measured by the measurement units 11 at the time of the actual operation of the robot device 10. The inference unit 44 is not used during machine learning processing.

Each of a motion teaching routine, a motion learning routine, and a motion generation routine that are sequentially executed by the robot system 100 according to the present embodiment is described in detail using flowcharts.

### (Motion Teaching Routine)

The motion teaching routine of the robot system 100 is described with reference to FIG. 3. This routine is a process of teaching a target motion to the robot and accumulating the original data in the original data accumulation unit 21.

First, in step S11, the target motion is taught to the robot device 10. A method for teaching to the robot device 10 is any method such as motion teaching by remote control using a remote control device, direct teaching in which a person directly teaches the robot, or a method in which a person programs the target motion in advance and reproduces the target motion.

In step S12, a sensor value of each drive unit 12 that has been measured by the measurement units 11 at the time of the teaching of the target motion to the robot device 10 is chronologically measured and is accumulated as the original data in the original data accumulation unit 21.

In step S13, the data generation unit 30 references the generation rule provided for data augmentation and stored in the generation rule storage unit 31 and causes the data processing unit 35 to execute at least one arithmetic process. The data augmentation is described later in detail.

Lastly, in step S14, the data generation unit 30 accumulates generated learning data in the learning data accumulation unit 22.

### (Motion Learning Routine)

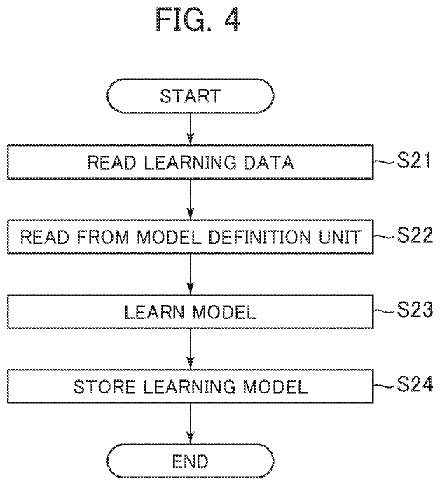

The motion learning routine of the robot system 100 is described with reference to FIG. 4. This routine is a process of using the large amount of learning data generated by the data generation unit 30 to execute machine learning on the model defined by the model definition unit 41 and storing information of various parameters constituting the model in the weight storage unit 43.

First, in step S21, the learning unit 42 reads learning data accumulated in the learning data accumulation unit 22.

In step S22, the learning unit 42 reads, from the model definition unit 41, any machine learning model (for example, a network configuration of a neural network or the like) defined by the user.

In step S23, the learning unit 42 uses the read learning data and the machine learning model to optimize the machine learning model in accordance with the objective function specified by the user.

Lastly, in step S24, the learning unit 42 causes various parameters constituting the machine learning model to be stored in the weight storage unit 43.

### (Motion Generation Routine)

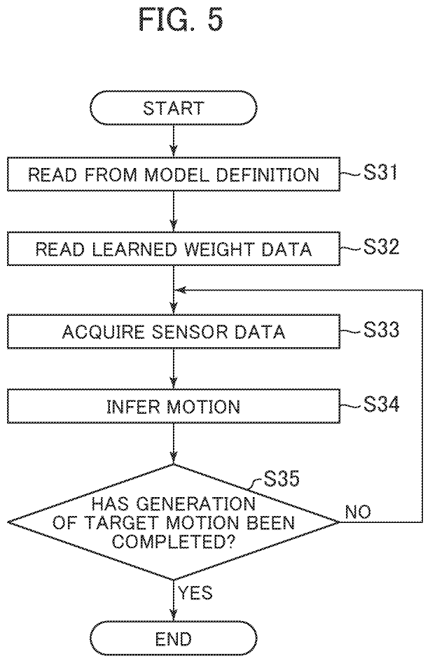

The motion generation routine of the robot system 100 is described with reference to FIG. 5. This routine is a process in which the inference unit 44 of the machine learning unit 40 infers an appropriate motion command value for the robot device 10 based on sensor data measured by the measurement units 11 at the time of the actual operation of the robot device 10, outputs the motion command value to the drive units 12, and sequentially generates a motion command value to implement a desired target motion.

First, in step S31, the inference unit 44 reads, from the model definition unit 41, the machine learning model defined by the user.

In step S32, the inference unit 44 reads, from the weight storage unit 43, the various parameters constituting the machine learning model learned in the motion learning routine.

In step S33, the inference unit 44 acquires various types of sensor data measured by the measurement units 11 at the time of the actual operation of the robot device 10.

In step S34, the inference unit 44 uses the various types of data sensor acquired and the read machine learning model to estimate a motion command value for causing the robot device 10 to perform a desired motion. The robot device 10 drives the drive units 12 based on the estimated motion command value.

In step S35, the inference unit 44 determines whether the target motion such as gripping of a moving target object has been implemented. When the implementation of the target motion is in progress, the motion generation routine returns to step S33. On the other hand, when the target motion has been implemented, the motion generation routine is ended.

By repeating the above-described steps, the robot device 10 can sequentially generate a motion based on sensor data measured by the measurement units 11 until the target motion is implemented.

### (Details of Learning Data Generation Step S13)

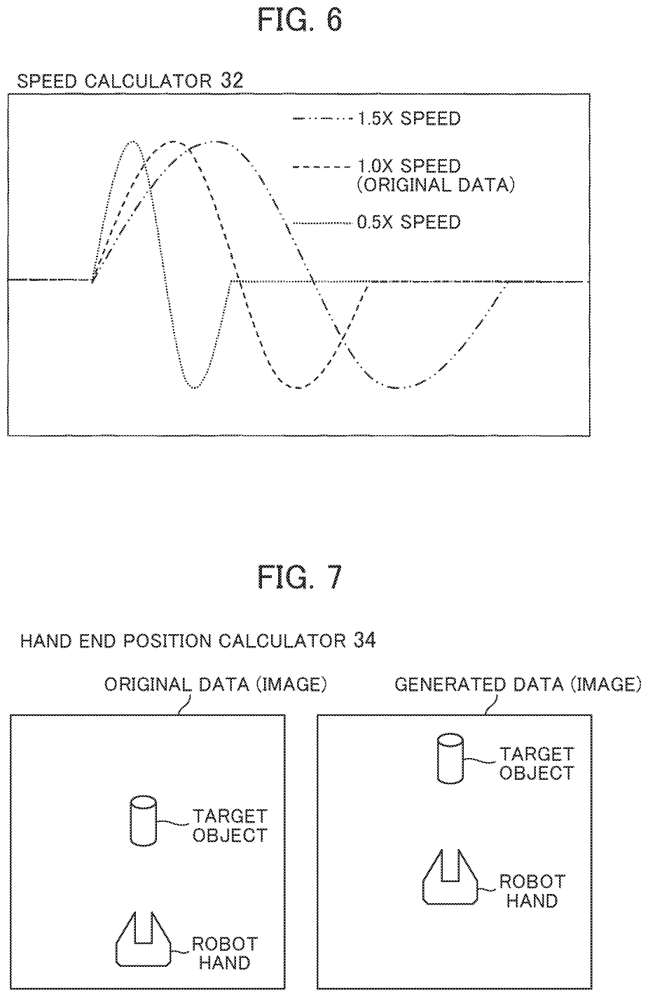

Next, a learning data generation method to be executed by the data generation unit 30 in step S13 of the motion teaching routine is described in detail with reference to FIGS. 6 to 9. In this case, particularly, a data augmentation method for gripping motion generation that requires a large amount of learning data and a large amount of calculation cost, such as the speed of a moving target object and the timing of gripping the moving target object, is described. A method for generating learning data for a motion for gripping a moving target object by mainly performing three types of preprocessing while focusing on the behavior of the moving target object will be described. Basically, as physical characteristics of an object, a moving speed and a position are used.

FIG. 6 illustrates sensor data generated by data augmentation by the speed calculator 32 and having different moving speeds. The speed calculator 32 samples (down sampling or up sampling) 1.0× speed original data indicated by a broken line at sampling intervals specified in advance to generate, as augmented data, new speed data such as 0.5× speed data indicated by a dotted line or 1.5× speed data indicated by a dashed-and-double-dotted line. In this case, sampling intervals or the like corresponding to the 0.5× speed and the 1.5× speed are a generation rule for the augmented data.

In addition, regarding the position of the hand end of the robot hand of the robot device 10, the hand end position calculator 34 changes sensor data on the position of the hand end of the robot by multiplying the sensor data by a constant to generate new hand end position data. In this case, as illustrated in FIG. 7, the position of the hand end of the robot in an image is changed in a pseudo manner by shifting the image in up, down, left, and right directions according to a change in the position of the hand end of the robot hand. Furthermore, the moving speed of the target object and the gripping timing for the recognition of the transition from the stationary state to the moving state are used as characteristics. In this case, an amount by which the image is shifted or the like is a generation rule for the augmented data.

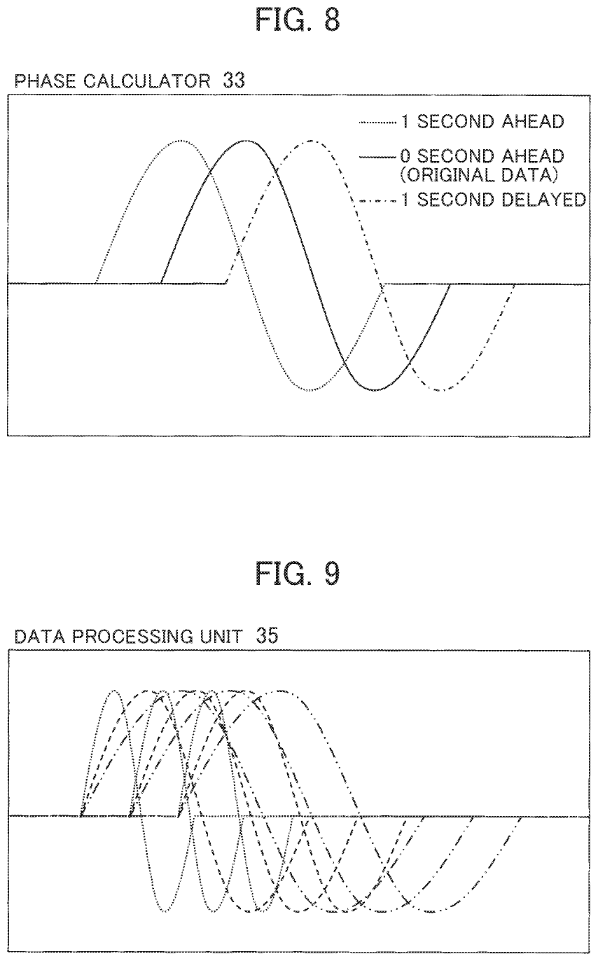

FIG. 8 illustrates sensor data generated by data augmentation by the phase calculator 33 and having different motion timings. The phase calculator 33 moves original data accumulated in the original data accumulation unit 21 and indicated by a solid line in a positive direction and/or a negative direction on a time axis according to a preset time change axis to generate new phase data as augmented data. In this case, an amount by which the original data is moved in the positive direction and/or the negative direction is a generation rule for the augmented data.

FIG. 9 conceptually illustrates a learning data generation process of generating a large amount of learning data by the data processing unit 35. As described above, in each of the speed calculator 32, the phase calculator 33, and the hand end position calculator 34, a plurality of augmented data items is generated. Therefore, the data processing unit 35 integrates data according to the number of data items generated by each of the calculators. When two types of augmented data for the speed, two types of augmented data for the phase, and zero types of augmented data for the position of the hand end are generated, the data processing unit 35 generates learning data of 9 patterns or 3×3×1 patterns in total in consideration of the original data and accumulates the learning data in the learning data accumulation unit 22.

In the above description, the augmented data is generated while focusing on the three types of data, which are the speed, the phase, and the hand end. However, for example, augmented data may be generated while focusing on other types of data, such as the size of a target object to be gripped.

By the process according to the present embodiment, various types of original data measured by the robot device 10 are augmented to learning data including pseudo augmented data based on the original data. In the present embodiment, by this data augmentation, it is possible to easily increase the number of learning data items several times to several tens of times. That is, in a case where a number n of types of data D₁ to Dₙ are present, when a number mn of types of data is prepared for the data Dₙ, the data processing unit 35 can easily generate a large amount of learning data of m₁, ×m₂, ×, . . . , ×mₙ types. Therefore, even when machine learning is executed on a complex object operation of gripping an approaching moving target object on a conveyor belt, it is possible to execute machine learning on an optimal parameter of the machine learning model of the robot device 10 with high accuracy.

As described above, according to the information processing device according to the present embodiment, it is possible to easily generate a large amount of learning data and thus it is possible to easily implement highly accurate deep learning even under a complex environment in which the robot device grips a moving target object.

### REFERENCE SIGNS LIST

100 . . . Robot system, 1 . . . Information processing device, 1a . . . CPU, 1b . . . ROM, 1c . . . RAM, 1d . . . External memory, 1e . . . Display unit, 1f . . . Input unit, 1g . . . Communication interface, 1h . . . System bus, 10 . . . Robot device, 11 . . . Measurement unit, 12 . . . Drive unit, 20 . . . Storage unit, 21 . . . Original data accumulation unit, 22 . . . Learning data accumulation unit, 30 . . . Data generation unit, 31 . . . Generation rule storage unit, 32 . . . Speed calculator, 33 . . . Phase calculator, 34 . . . Hand end position calculator, 35 . . . Data processing unit, 40 . . . Machine learning unit, 41 . . . Model definition unit, 42 . . . Learning unit, 43 . . . Weight storage unit, 44 . . . Inference unit

1. An information processing device that generates time-series learning data based on time-series original data acquired from a robot device, comprising:
a memory that stores an augmented data generation rule for at least one of at least one change value of a speed, at least one change value of a phase, at least one change value of a position, or at least one change value of a size; and
a processor that uses at least one of the change values of the augmented data generation rule to augment the original data so as to generate time-series augmented data and outputs the time-series learning data including the time-series augmented data and the time-series original data.

2. The information processing device according to claim 1, wherein the processor executes machine learning on a machine learning model using the time-series learning data such that the robot device performs a target motion.

3. The information processing device according to claim 2, wherein the processor executes the machine learning on the machine learning model based on a model registered in a model definition unit in advance.

4. The information processing device according to claim 3, wherein the processor causes various parameters of the machine learning model subjected to the machine learning to be stored in a weight storage unit.

5. The information processing device according to claim 2, wherein the processor generates a motion command value for performing the target motion based on the machine learning model and the time-series original data measured from the robot device in actual operation.

6. An information processing method for generating time-series learning data based on time-series original data acquired from a robot device, comprising:
generating time-series augmented data by using at least one of at least one change value of a speed, at least one change value of a phase, at least one change value of a position, or at least one change value of a size to augment the original data; and
outputting the time-series learning data including the time-series augmented data and the time-series original data.
